(19) United States
(12) Patent Application Publication
(10) Pub. No.: US 2025/0033387 A1
(43) Pub. Date: Jan. 30, 2025

(54) TRAY AND IMAGE RECORDING APPARATUS

(71) Applicant: BROTHER KOGYO KABUSHIKI KAISHA, Nagoya (JP)

(72) Inventor: NAO MORIMOTO, Nagoya (JP)

(73) Assignee: BROTHER KOGYO KABUSHIKI KAISHA, Nagoya (JP)

(21) Appl. No.: 18/785,183

(22) Filed: Jul. 26, 2024

(30) Foreign Application Priority Data
Jul. 28, 2023 (JP) 2023-123038

(51) Int. Cl. B41J 13/10; B41J 13/08; B41J 29/13; B65H 1/04; B65H 16/02

(52) U.S. Cl. CPC B41J 13/103; B41J 13/08; B41J 29/13; B65H 1/04; B65H 16/02; B65H 2405/36; B65H 2405/40

(57) ABSTRACT

A tray includes: a first accommodating part configured to accommodate a rolled first sheet medium; and a second accommodating part disposed side by side with respect to the first accommodating part in a first direction and having a support surface configured to support a second sheet medium. The second accommodating part is configured to accommodate a plurality of sheets of the second sheet medium in a stacked state. The second accommodating part is configured to be either in a first state where a length of the support surface in the first direction is a first length, or in a second state where the length of the support surface in the first direction is a second length shorter than the first length.

### REFERENCE TO RELATED APPLICATIONS

This application claims priority from Japanese Patent Application No. 2023-123038 filed on Jul. 28, 2023. The entire content of the priority application is incorporated herein by reference.

### BACKGROUND ART

Conventionally, a facsimile (image recording apparatus) which includes a sheet feed cassette (tray) is known. The sheet feed cassette has a roll sheet placement part (first accommodating part) to place a roll sheet (rolled first sheet medium) therein and a cut sheet placement part (second accommodating part) to place a cut sheet (second sheet medium) therein.

### SUMMARY

The sheet feed cassette is supported movably by a facsimile body. The roll sheet placement part and the cut sheet placement part are disposed while being aligned along a moving direction of the sheet feed cassette. Further, in a state where the sheet feed cassette is attached to the facsimile body, an entirety of the sheet feed cassette is accommodated in the facsimile body. Due to this, the size, of the cut sheet placement part, in the moving direction of the sheet feed cassette is relatively small. As a result, the variety of sheet sizes that can be accommodated in the cut sheet placement part might be reduced.

An object of the present disclosure is to provide a tray and an image recording apparatus each of which is capable of accommodating a plurality of kinds of a sheet-like medium of which sizes are mutually different.

A tray of the present disclosure includes: a first accommodating part configured to accommodate a rolled first sheet medium; and a second accommodating part disposed side by side with respect to the first accommodating part in a first direction and having a support surface configured to support a second sheet medium. The second accommodating part is configured to accommodate a plurality of sheets of the second sheet medium in a stacked state. The second accommodating part is configured to be either in a first state where a length of the support surface in the first direction is a first length, or in a second state where the length of the support surface in the first direction is a second length shorter than the first length.

An image recording apparatus of the present disclosure includes: the tray as described above; and a casing configured to support the tray to be movable in the first direction. The casing has: a recording part configured to record an image on each of the first sheet medium and the second sheet medium; and a conveyor configured to convey the first sheet medium or the second sheet medium from the tray toward the recording part.

According to the tray and the image recording apparatus of the present disclosure, even in a case where the tray and the image recording apparatus each have the first accommodating part which accommodates the first sheet medium having the roll shape, the plurality of kinds of the second sheet medium of which sizes are mutually different can be accommodated in the second accommodating part.

### BRIEF DESCRIPTION OF DRAWINGS

FIG. 1 is a schematic side view depicting an internal structure of a printer according to an embodiment of the present disclosure in a case of a second accommodating part being in a contracted state.

FIG. 2 is a perspective view of a feed tray depicted in FIG. 1.

FIG. 3 is a plan view of the feed tray depicted in FIG. 2 in the case of the second accommodating part being in the contracted state.

FIG. 4 is a plan view of the feed tray in a case of the second accommodating part being in an extended state.

FIG. 5 is a schematic side view depicting the internal structure of the printer according to the embodiment of the present disclosure in the case of the second accommodating part being in the extended state.

FIG. 6 is a plan view of a feed tray according to a modification of the present disclosure.

### DESCRIPTION

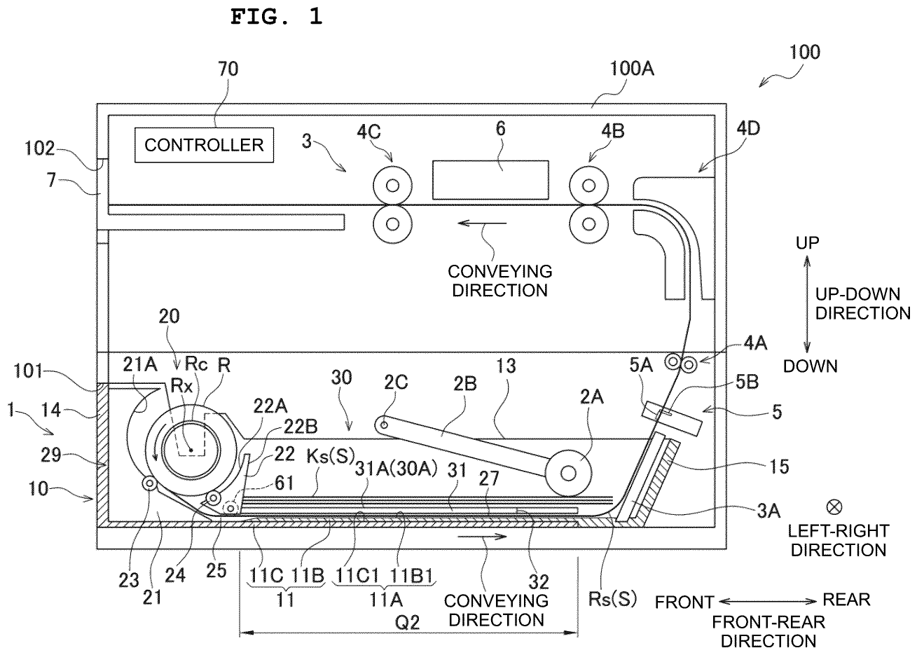

A printer 100 (an example of an “image recording apparatus” of the present disclosure) according to an embodiment of the present disclosure will be described below with reference to FIG. 1. Note that the up-down direction, the front-rear direction (an example of a “first direction” of the present disclosure), and the left-right direction depicted in FIG. 1 are the up-down direction, the front-rear direction, and the left-right direction of the printer 100. The left-right direction is defined based on a front view of the printer 100. The front side in the sheet surface of FIG. 1 is the right side, and the rear side in the sheet surface of FIG. 1 is the left side.

### Overall Configuration of Printer 100

As depicted in FIG. 1, the printer 100 mainly includes a casing 100A, a feed tray 1, a conveyor 3, a cutting part 5, a head 6, a sheet discharge tray 7, and a controller 70. The feed tray 1 (an example of a “tray” of the present disclosure) is disposed below the head 6 inside the casing 100A. The feed tray 1 is insertable into and detachable from the casing 100A in the front-rear direction through an opening 101 defined in the front wall of the casing 100A. That is, the feed tray 1 is movable along the front-rear direction between a first position at which the feed tray 1 is inside the casing 100A (the position depicted in FIG. 1) and a second position at which the feed tray 1 is outside the casing 100A. The second position in the present embodiment is a position in front of the casing 100A. In a case where the feed tray 1 is located at the second position, the feed tray 1 is in a state of being detached from the casing 100A.

The feed tray 1 has a first accommodating part 20 capable of accommodating a roll body R, and a second accommodating part 30 capable of accommodating a plurality of cut sheets Ks (each of which is an example of a “second sheet medium” of the present disclosure) in a stacked state. The roll body R has a roll sheet Rs (an example of a “rolled first sheet medium” of the present disclosure) wound around the outer circumferential surface of a core member Rc having a cylindrical shape. The roll sheet Rs is longer than each of the cut sheets Ks. The roll body R is accommodated in the first accommodating part 20 such that the axial direction of a central axis Rx of the roll body R coincides with the left-right direction.

Note that, for the sake of description, FIG. 1 depicts a state that the feed tray 1 accommodates both the roll body R and the cut sheets Ks. However, in a case where an image is recorded on the roll sheet Rs in the printer 100, the roll body R is accommodated in the feed tray 1 and the cut sheets Ks are removed from the feed tray 1. On the other hand, in a case where an image is recorded on the cut sheet(s) Ks, the cut sheets Ks are accommodated in the feed tray 1 and the roll body R is removed from the feed tray 1 or the roll sheet R is removed from a conveyance route.

Further, the feed tray 1 in the present embodiment is configured such that the entirety of the feed tray 1 can be pulled out from the casing 100A. However, the feed tray 1 may be configured such that only a part of the feed tray 1 is pulled out from the casing 100A. For example, the feed tray 1 may be configured such that the feed tray 1 is pulled only up to a position between the first position and the second position. In this case also, the feed tray 1 is preferably configured such that the roll body Rs and the cut sheet(s) Ks can be accommodated, from the outside of the casing 100A, in the feed tray 1.

The conveyor 3 is configured to convey the roll sheet Rs unwound from the roll body R, or the cut sheet(s) Ks, along the conveying direction. As depicted in FIG. 1, the conveyor 3 includes a feeding roller 2A, an arm 2B, a separation wall 3A, an intermediate roller pair 4A, a conveying roller pair 4B, a sheet discharging roller pair 4C, and a guide 4D.

The feeding roller 2A feeds the roll sheet Rs unwound from the roll body R accommodated in the first accommodating part 20, or a cut sheet Ks, of the cut sheets Ks accommodated in the second accommodating part 30, from the feed tray 1. The roll sheet Rs and the cut sheet Ks fed by the feeding roller 2A are fed out from the feed tray 1 in the same route. In the following description, in a case where the cut sheet(s) Ks and the roll sheet Rs are not distinguished from each other, the cut sheet(s) Ks and the roll sheet Rs will be referred to as a “sheet S”.

The feeding roller 2A is pivotally supported at an end part of the arm 2B. The feeding roller 2A is rotated about an axis, which is extended in the left-right direction, by driving a non-illustrated feeding motor.

The arm 2B is rotatably supported by a support shaft 2C. The support shaft 2C is supported by the casing 100A. The arm 2B is biased by a non-illustrated biasing member so that the feeding roller 2A approaches a bottom surface 11A of the feed tray 1. The arm 2B rotates about the support shaft 2C to thereby cause the feeding roller 2A to move between a contact position and a separation position. At the contact position, the feeding roller 2A contacts with a friction member 18 disposed on the bottom surface 11A of the feed tray 1. At the separation position, the feeding roller 2A is separated from the friction member 18. The arm 2B is retractable, by a non-illustrated retracting mechanism, to a retracted position in conjunction with a movement of the feed tray 1 from the first position to the second position. A tray body 10 of the feed tray 1 and the feeding roller 2A do not interfere with each other at the retracted position. The separation position is a position to which the feeding roller 2A moves in a case where the arm 2B moves to the retracted position.

Further, the feeding roller 2A selectively takes a first feed position and a second feed position, between the contact position and the separation position. At the first feed position, the feeding roller 2A contacts with the roll sheet Rs supported by the bottom surface 11A of the feed tray 1. At the second feed position, the feeding roller 2A contacts with the cut sheet(s) Ks accommodated in the second accommodating part 30.

In a case where the feeding motor 2M is driven under the control of the controller 70, the feeding roller 2A rotates so as to apply conveying force in a direction from the front to the rear, with respect to the sheet S which is in contact with the feeding roller 2A. As a result, the sheet S is fed out from the feed tray 1.

The separation wall 3A is disposed so as to prevent double feeding of the cut sheets Ks in a case where the cut sheets Ks are fed from the feed tray 1. The separation wall 3A extends obliquely upward from the bottom surface 11A of the feed tray 1. The separation wall 3A is disposed in the casing 100A. As depicted in FIG. 1, the separation wall 3A is disposed in a rear end part of the feed tray 1 in the front-rear direction.

The intermediate roller pair 4A is constructed of a driving roller which is rotated by driving a non-illustrated intermediate motor, and a driven roller which is rotated with the rotation of the driving roller. In a case where the intermediate motor is driven under the control of the controller 70, the intermediate roller pair 4A is rotated while holding the sheet S so as to convey the sheet S. The intermediate roller pair 4A is positioned above the separation wall 3A. The intermediate roller pair 4A conveys the sheet S fed out from the feed tray 1 upward, while holding the sheet S. The guide 4D is positioned above the intermediate roller pair 4A. The guide 4D guides the sheet S, which has been conveyed upward by the intermediate roller pair 4A, forward.

The conveying roller pair 4B is constructed of a driving roller which is rotated by driving a non-illustrated conveying motor, and a driven roller which is rotated with the rotation of the driving roller. The sheet discharging roller pair 4C is constructed of a driving roller which is rotated by driving a non-illustrated sheet discharging motor, and a driven roller which is rotated with the rotation of the driving roller. In a case where the conveying motor and the sheet discharging motor are driven by the control of the controller 70, the conveying roller pair 4B and the sheet discharging roller pair 4C are rotated while holding the sheet S so as to convey the sheet S. The conveying roller pair 4B is positioned behind the head 6, and the sheet discharging roller pair 4C is positioned in front of the head 6. The conveying roller pair 4B conveys the sheet S, which is guided forward by the guide 4D, forward while holding the sheet S. The sheet discharging roller pair 4C conveys the sheet S, which is conveyed forward by the conveying roller pair 4B, forward while holding the sheet S.

As depicted in FIG. 1, the cutting part 5 is positioned between the separation wall 3A and the intermediate roller pair 4A. The cutting part 5 includes a fixed blade 5A which is elongated in the left-right direction, and a disc-shaped rotary blade 5B which is movable in the left-right direction while contacting with the fixed blade 5A. The rotary blade 5B is rotated by driving a non-illustrated cutting motor and reciprocates along the left-right direction. In a case where the cutting motor is driven under the control of the controller 70, the roll sheet Rs unwound from the roll body R and conveyed is thereby cut in the left-right direction by the fixed blade 5A and the rotary blade 5B. With this, a rear end is formed in the roll sheet Rs which is to be fed to the sheet discharge tray 7.

A plurality of nozzles (not depicted) is formed in a lower surface of the head (an example of a “recording part” of the present disclosure) 6. The head 6 includes a driver IC (not depicted). The head 6 records an image on the sheet S conveyed by the conveyor 3. In a case where the sheet S conveyed by the conveyor 3 passes through an image recording position facing the lower surface of the head 6, the controller 70 controls the driver IC to thereby cause ink to be ejected from the nozzles and to form an image on the sheet S. Note that the head 6 may be of either the line system in which the ink is ejected from the nozzles in a state that the position of the head 6 is fixed, or the serial system in which the ink is ejected from the nozzles while the head 6 is moving in the left-right direction.

The sheet discharge tray 7 is disposed, inside the casing 100A, in front of the head 6 and above the feed tray 1. The sheet discharge tray 7 is insertable into and detachable from the casing 100A along the front-rear direction through an opening 102 defined in the front wall of the casing 100A. The sheet discharge tray 7 receives the sheet S on which an image is formed by the head 6 and is conveyed forward by the sheet discharging roller pair 4C.

The controller 70 of the printer 100 is connected to the feeding motor, the intermediate motor, the conveying motor, the sheet discharging motor, the cutting motor, and the driver IC by an internal bus (not depicted). The controller 70 has a CPU, a ROM, and a RAM. A program, data, etc., by which the CPU performs a variety of kinds of control are stored in the ROM. The RAM temporarily stores data to be used by the CPU in a case where the CPU executes a program.

### Configuration of Feed Tray 1

Next, the configuration of the feed tray 1 will be described with reference to FIGS. 1 to 5. In the following description, the respective parts of the feed tray 1 will be described, based on a posture of the feed tray 1 in a state that the feed tray 1 is attached to the casing 100A.

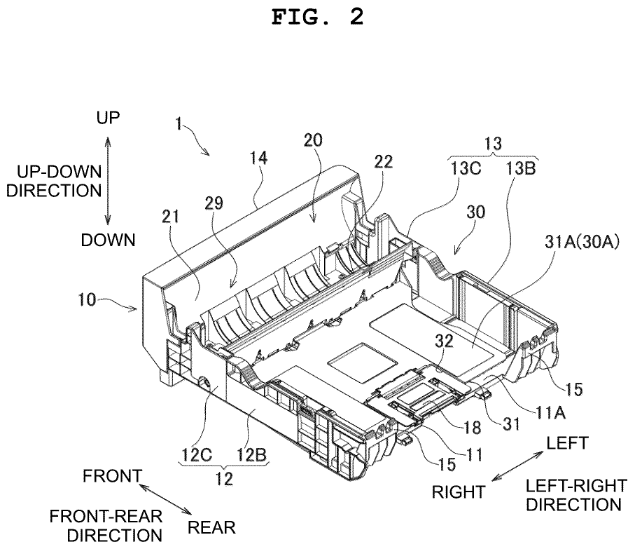

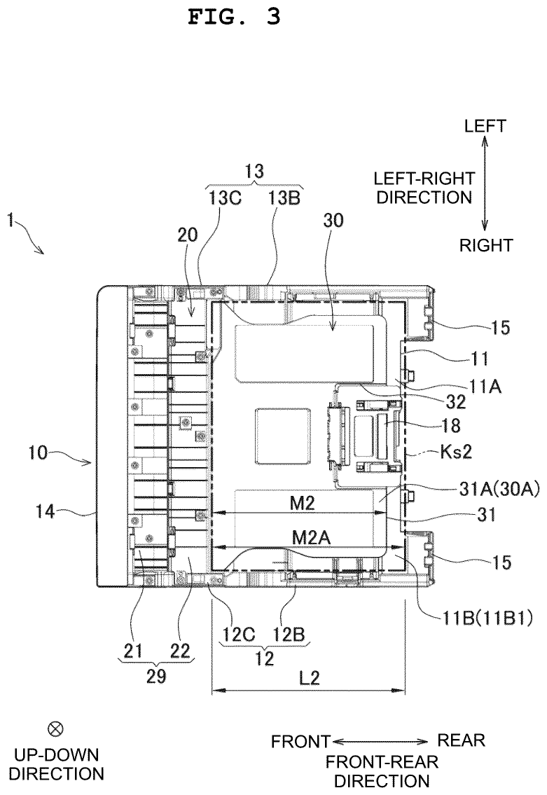

The feed tray 1 has the tray body 10. As depicted in FIGS. 2 and 3, the tray body 10 has a bottom wall 11 and four side walls 12 to 15 disposed in peripheral edge parts of the bottom wall 11, and the tray body 10 is formed in a box shape which is opened upward.

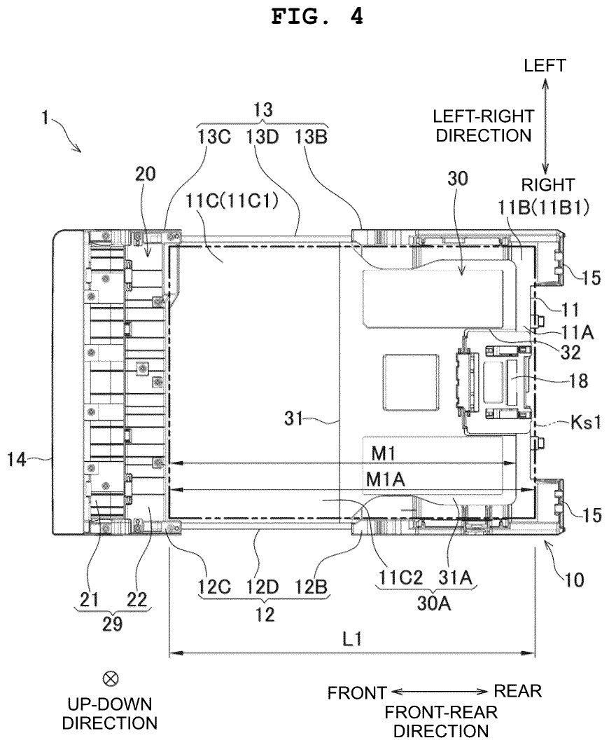

As depicted in FIGS. 1 and 4, the bottom wall 11 has a first bottom wall 11B and a second bottom wall 11C. Each of the first bottom wall 11B and the second bottom wall 11C has a rectangular planar shape extending in the front-rear direction and the left-right direction. An upper surface 11B1 of the first bottom wall 11B and an upper surface 11C1 (an example of a “second surface” of the present disclosure) of the second bottom wall 11C construct the bottom surface 11A of the bottom wall 11. As depicted in FIG. 1, the first bottom wall 11B is disposed behind the second bottom wall 11C. Further, a central part and a front part of the first bottom wall 11B in the front-rear direction are disposed above the second bottom wall 11C, and are disposed so as to overlap with the second bottom wall 11C in the up-down direction.

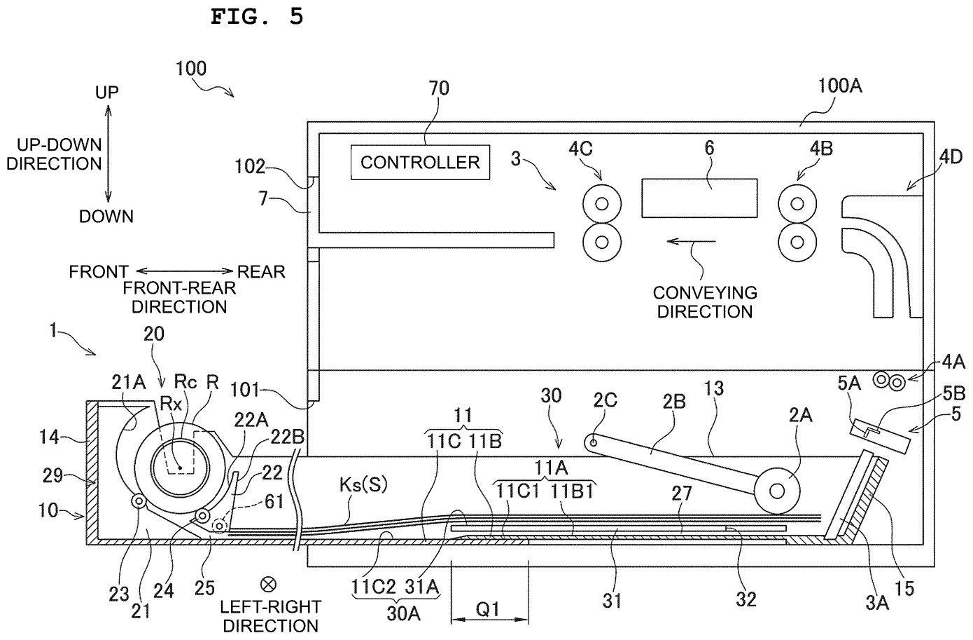

The first bottom wall 11B is configured to be slidable in the front-rear direction with respect to the second bottom wall 11C as depicted in FIGS. 1, 4, and 5. The first bottom wall 11B and the second bottom wall 11C are also configured to be movable between a contracted position as depicted in FIGS. 1 and 3 and an expanded position as depicted in FIGS. 4 and 5. At the contracted position, the first bottom wall 11B and the second bottom wall 11C are the closest to each other in the front-rear direction and the overall length of the feed tray 1 in the front-rear direction is the smallest. At the expanded position, the first bottom wall 11B and the second bottom wall 11C are the farthest from each other in the front-rear direction and the overall length of the feed tray 1 in the front-rear direction is the greatest.

Among the four side walls 12 to 15, the pair of side walls 12 and 13 disposed on the left and right sides extend upward from both left and right end parts of the bottom wall 11. Further, the pair of side walls 12 and 13 extend in the front-rear direction from a front end part to a rear end part of the bottom wall 11.

As depicted in FIG. 4, the side wall 12 has a first side wall 12B, a second side wall 12C, and a connecting wall 12D. The first side wall 12B is configured to be slidable in the front-rear direction with respect to the second side wall 12C and the connecting wall 12D. The first side wall 12B extends upward and in the front-rear direction at a right end part of the first bottom wall 11B. The first side wall 12B has a groove (not depicted) which extends in the front-rear direction and which can accommodate the connecting wall 12D. The second side wall 12C and the connecting wall 12D extend upward and in the front-rear direction at a right end part of the second bottom wall 11C. Further, the connecting wall 12D extends rearward from a rear end surface, of the second side wall 12C, which faces the first side wall 12B. Furthermore, the first side wall 12B, the second side wall 12C and the connecting wall 12D are also configured to be movable corresponding to the range of movement of the first bottom wall 11B and the second bottom wall 11C.

As depicted in FIG. 4, the side wall 13 has a first side wall 13B, a second side wall 13C, and a connecting wall 13D. The first side wall 13B is also configured to be slidable in the front-rear direction with respect to the second side wall 13C and the connecting wall 13D. The first side wall 13B extends upward and in the front-rear direction at a left end part of the first bottom wall 11B. The first side wall 13B has a groove (not depicted) which extends in the front-rear direction and which can accommodate the connecting wall 13D. The second side wall 13C and the connecting wall 13D extend upward and in the front-rear direction at a left end part of the second bottom wall 11C. Further, the connecting wall 13D extends rearward from a rear end surface, of the second side wall 13C, which faces the first side wall 13B. Furthermore, the first side wall 13B, the second side wall 13C and the connecting wall 13D are also configured to be movable corresponding to the range of movement of the first bottom wall 11B and the second bottom wall 11C.

The side wall 14 extends upward from a front end part of the bottom wall 11. The side wall 14 extends in the left-right direction from the right end part to the left end part of the bottom wall 11.

Two side walls 15 are disposed, respectively, at both end parts on the rear side of the bottom wall 11. The two side walls 15 are disposed to be separated from each other in the left-right direction. In a case where the feed tray 1 is attached to the casing 100A, the separation wall 3A (see FIG. 1) is located between the two side walls 15 aligned in the left-right direction.

The first accommodating part 20 accommodates the roll body R in a posture in which the axial direction of a central axis Rx coincides with the left-right direction. The first accommodating part 20 and the second accommodating part 30 are disposed side by side in the front-rear direction. The first accommodating part 20 is positioned in front of the second accommodating part 30.

Further, the first accommodating part 20 has a support part 29 which supports the roll body R from below, as depicted in FIG. 1. The support part 29 is disposed in a front part of the second bottom wall 11C. The support part 29 has two holders 21 and 22 and two rollers 23 and 24. The two holders 21 and 22 are disposed to be separated from each other in the front-rear direction. The holder 21 is positioned in front of the holder 22. Each of the two holders 21 and 22 extends in the left-right direction.

The roller 23 is attached to the holder 21 to be rotatable about a rotation axis extending along the left-right direction. The roller 24 is attached to the holder 22 to be rotatable about a rotation axis extending in the left-right direction. The rollers 23 and 24 are disposed to be separated from each other in the front-rear direction. The roller 23 is positioned above the roller 24. The two rollers 23 and 24 support the roll body R from below in a state that the two rollers 23 and 24 contact with an outer peripheral surface on the lower side of the roll body R.

As depicted in FIG. 1, the holder 21 has a curved surface 21A which covers the outer peripheral surface on the front side of the roll body R. The holder 22 has a curved surface 22A which covers the outer peripheral surface on the rear side, mainly the lower portion, of the roll body R. The curved surface 22A is formed in a front surface of the holder 22. The holder 22 has a guide surface 22B which aligns the front ends of the cut sheets Ks accommodated in the second accommodating part 30. The guide surface 22B is formed on a rear surface of the holder 22.

Further, the holder 22 is disposed so that a passage 25 causing the roll sheet Rs unwound from the roll body R to pass therethrough is defined between the lower surface of the holder 22 and the bottom surface 11A. The roll sheet Rs unwound from the roll body R accommodated in the first accommodating part 20 is caused to pass through the passage 25 from a location between the two holders 21 and 22 and is drawn up on the friction member 18, along the bottom surface 11A.

As depicted in FIG. 1, a roller 61 is disposed in a lower part of the holder 22. The roller 61 is attached to the holder 22 so that the roller 61 is rotatable about a rotating shaft which extends in the left-right direction. A lower portion of the roller 61 is disposed below the lower surface of the holder 22 and disposed in the passage 25. The roller 61 is a driven roller which rotates with the conveyance of the roll sheet Rs.

As depicted in FIG. 1, the second accommodating part 30 has a support plate 31 disposed on the first bottom wall 11B of the bottom wall 11. The support plate 31 is a plate-like member which extends in the front-rear direction and the left-right direction, and which supports the cut sheet(s) Ks from below by an upper surface 31A (an example of a “first surface” of the present disclosure) thereof. A part of the front end of the support plate 31 is inserted into a lower part of the holder 22 in a case where the first bottom wall 11B and the second bottom wall 11C are at the contracted position. Further, the support plate 31 is configured such that a rear end part of the support plate 31 is swingable upward and downward, with the part inserted into the holder 22 as the fulcrum. Furthermore, the support plate 31 extends rearward from the fulcrum to the vicinity of a rear end part of the bottom surface 11A.

On the other hand, as depicted in FIGS. 4 and 5, in a case where the first bottom wall 11B and the second bottom wall 11C are located at the expanded position, the part of the front end of the support plate 31 is pulled out from the lower part of the holder 22 and is located on the upper surface 11B1. Note that the support plate 31 may be detached from the feed tray 1 in a case where the first bottom wall 11B and the second bottom wall 11C are located at the expanded position.

Further, as depicted in FIG. 1, the support plate 31 and the bottom wall 11 define a route 27. The roll sheet Rs unwound from the roll body R passes through the route 27. In other words, the support plate 31 is disposed so as to face the bottom surface 11A so that the roll sheet Rs can pass between the support plate 31 and the bottom surface 11A. Note that the support plate 31 also has the function of preventing the roll sheet Rs passing between the support plate 31 and the bottom surface 11A from curling.

The support plate 31 has a cutout part 32 formed in the rear end part thereof. The cutout part 32 is disposed at the center of the support plate 31 in the left-right direction. The cutout part 32 is disposed on a movement trajectory of the feeding roller 2A which is movable from the contact position to the separation position. Note that the friction member 18 is located in the cutout part 32 of the support plate 31, as depicted in FIG. 3.

The second accommodating part 30 in the present embodiment is configured such that the length in the front-rear direction can be changed by sliding the first bottom wall 11B and the second bottom wall 11C forward and rearward. That is, as depicted in FIG. 4, in a case where the first bottom wall 11B and the second bottom wall 11C are located at the expanded position, the support surface 30A of the second accommodating part 30 is constructed of the upper surface 31A of the support plate 31 and an area 11C2, of the upper surface 11C1 of the second bottom wall 11C, which is behind the holder 22, and supports the cut sheet(s) Ks accommodated in the second accommodating part 30 from below. As depicted in FIG. 5, in a case where the first bottom wall 11B and the second bottom wall 11C are located at the expanded position, an overlap amount Q1 of the upper surface 31A and the upper surface 11C1 in the up-down direction is the smallest. In this state, the second accommodating part 30 is in an extended state (an example of a “first state” of the present disclosure) in which a length L1 in the front-rear direction of the second accommodating part 30 (see FIG. 4) is the greatest. Further, in the embodiment, a length M1 (an example of a “first length” of the present disclosure) in the front-rear direction of the support surface 30A in the extended state is shorter than the length L1 to some extent.

Note that in a case where the support plate 31 is detached from the feed tray 1 while the second accommodating part 30 is in the extended state, the support surface 30A is constructed of the upper surface 11B1 of the first bottom wall 11B and the area 11C2. In this situation, a length MIA of the support surface 30A in the front-rear direction is approximately the same as the length L1, as depicted in FIG. 4.

In the present embodiment, the length L1 of the second accommodating part 30 in the extended state corresponds to the longest side of a cut sheet Ks1 of an A3 size or a legal size (depicted by two-dot chain lines in FIG. 4). In other words, the second accommodating part 30 in the extended state can accommodate the cut sheet Ks1. Note that a width in the left-right direction of the second accommodating part 30 corresponds to the width of the cut sheet Ks1 of the A3 size or the legal size.

Further, as depicted in FIG. 3, in a case where the first bottom wall 11B and the second bottom wall 11C are located at the contracted position, the support surface 30A of the second accommodating part 30 is defined by the upper surface 31A of the support plate 31, and supports the cut sheet Ks accommodated in the second accommodating part 30 from below. As depicted in FIG. 1, in a case where the first bottom wall 11B and the second bottom wall 11C are at the contracted position, are in a state that an overlap amount Q2 of the upper surface 31A and the upper surface 11C1 in the up-down direction is the greatest. In this state, the second accommodating part 30 is in a contracted state (an example of a “second state” of the present disclosure) where a length L2 in the front-rear direction (see FIG. 3) of the second accommodating part 30 is the smallest. Furthermore, in the present embodiment, a length M2 (an example of a “second length” of the present disclosure) in the front-rear direction of the support surface 30A in the contracted state is shorter than the length L2 to some extent. Note that in a case where the support plate 31 is detached from the feed tray 1 while the second accommodating part 30 is in the contracted state, the support surface 30A is constructed of the upper surface 11B1 of the first bottom wall 11B. In this situation, a length M2A of the support surface 30A in the front-rear direction is approximately the same as the length L2, as depicted in FIG. 3.

In the present embodiment, the length L2 of the second accommodating part 30 in the contracted state corresponds to the shortest side of a cut sheet Ks2 of an A4 size or a letter size (depicted by two-dot chain lines in FIG. 3). In other words, the second accommodating part 30 in the contracted state cannot accommodate the cut sheet Ks1, whereas the second accommodating part 30 in the contracted state can accommodate the cut sheet Ks2.

### Procedure for Setting Roll Sheet Rs

In a case where an image is to be recorded on the roll sheet Rs, the feed tray 1 is pulled and detached from the casing 100A. The feed tray 1 is in a state that the second accommodating part 30 is in the contracted state. In this situation, in a case where the cut sheet(s) Ks is (are) accommodated in the second accommodating part 30, the cut sheet s) Ks is (are) taken out. Then, the roll body R is accommodated in the first accommodating part 20 by holding both left and right ends of the core member Rc of the roll body R. In this situation, a part of the roll sheet Rs unwound from the roll body R is inserted into the passage 25. Afterwards, the roll body R is rotated counterclockwise in FIG. 1, and the roll sheet Rs is passed through the route 27. Then, the roll sheet Rs is pulled out until a leading end of the roll sheet Rs is located downstream of the friction member 18 in the conveying direction. In this state, the feed tray 1 is moved from the second position to the first position. As a result, the feeding roller 2A and the friction member 18 hold the roll sheet Rs, and the roll sheet Rs can be fed.

### Procedure for Setting Cut Sheet Ks1

In a case where an image is to be recorded on a cut sheet Ks1, the feed tray 1 is pulled and detached from the casing 100A in a similar manner as that described above. In this situation, in a case where the roll body R is accommodated in the first accommodating part 20, the roll body R is taken out from the first accommodating part 20, or the roll sheet Rs is removed from the route 27. Afterwards, the feed tray 1 is extended as depicted in FIG. 4. That is, the second accommodating part 30 is in the extended state. Then, a plurality of cut sheets Ks1 is accommodated in the stacked state in the second accommodating part 30. In this state, as depicted in FIG. 5, the feed tray 1 is moved from the second position to the first position. As a result, the feeding roller 2A comes into contact with an uppermost cut sheet Ks1 located at the top of the plurality of cut sheets Ks1, and the cut sheets Ks1 can be fed. In this state, the feed tray 1 protrudes forward from the casing 100A. In this situation, a cover (not depicted) may be disposed in a protruding part of the feed tray 1. As a modification, the feed tray 1 may include, in advance, a cover (not depicted) which is configured to cover at least a center part to a front part in the front-rear direction of the feed tray 1 from above.

### Procedure for Setting Cut Sheet Ks2

In a case where an image is to be recorded on a cut sheet Ks2, the feed tray 1 is pulled and detached from the casing 100A in a similar manner as that described above. In this situation, in a case where the roll body R is accommodated in the first accommodating part 20, the roll body R is taken out from the first accommodating part 20 or the roll sheet Rs is removed from the route 27. Afterwards, the feed tray 1 is contracted as depicted in FIG. 1. That is, the second accommodating part 30 is in the contracted state. Then, a plurality of cut sheets Ks2 is accommodated in the stacked state in the second accommodating part 30. In this state, the feed tray 1 is moved from the second position to the first position. As a result, the feeding roller 2A comes into contact with an uppermost cut sheet Ks2 among the plurality of cut sheets Ks2, and the cut sheets Ks2 can be fed.

As described above, the feed tray 1 and the printer 100 of the present embodiment are capable of selectively adjusting the length in the front-rear direction of the second accommodating part 30 of the feed tray 1 to the length L1 or the length L2 depending on the size of the cut sheet Ks to be accommodated in the second accommodating part 30. Therefore, even in a case where the feed tray 1 has the first accommodating part 20 which accommodates the roll body R, the plurality of types of the cut sheets Ks1 and the cut sheet Ks2 of which sizes are mutually different can be accommodated in the second accommodating part 30.

Further, the overlap amount Q2 by which the upper surface 31A and the upper surface 11C1 overlap in the case where the second accommodating part 30 is in the contracted state is greater than the overlap amount Q1 by which the upper surface 31A and the upper surface 11C1 overlap in the case where the second accommodating part 30 is in the extended state. In this manner, the length of the second accommodating part 30 in the front-rear direction can be changed by a simple operation of moving the upper surface 11C1 in the front-rear direction with respect to the upper surface 31A.

As a modification, the support part 29 in the above-described embodiment may be configured to be detachable with respect to the first accommodating part 20. That is, the support part 29 may be detachable from the bottom wall 11 of the feed tray 1. This allows the cut sheets Ks to be placed in a placement area of the support part 29 by a simple operation of detaching the support part 29 from the first accommodating part 20. With this, the placement area can be utilized as a part of the second accommodating part 30, thereby allowing the length of the second accommodating part 30 in the front-rear direction to be increased. Therefore, even if an amount of movement of the upper surface 11C1 in the front-rear direction with respect to the upper surface 31A is reduced by an amount corresponding to the length in the front-rear direction of the second accommodating part 30 which is expanded by detaching the support part 29, the second accommodating part 30 can be changed from a state that the second accommodating part 30 can accommodate the cut sheets Ks2 (an example of the “second state” of the present disclosure) to a state that the second accommodating part 30 can accommodate the cut sheets Ks1 (an example of the “first state” of the present disclosure).

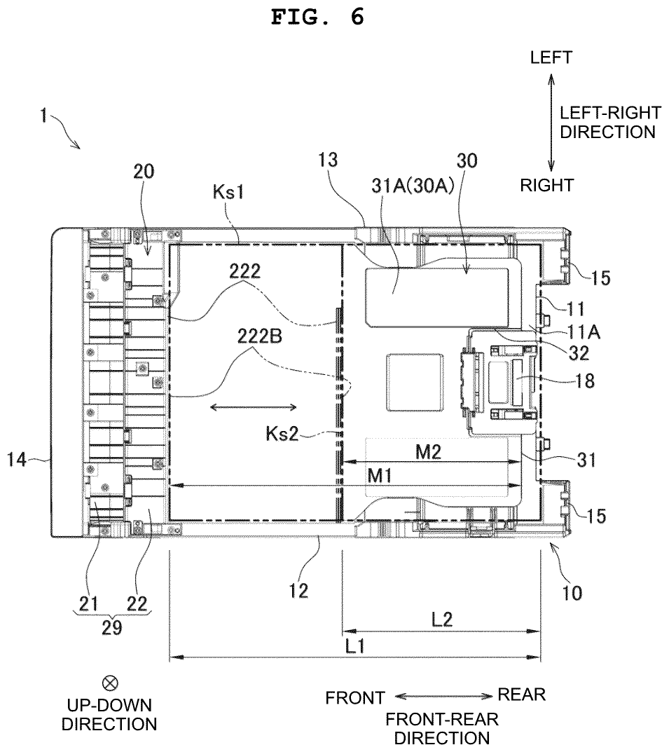

Further, as another modification, the holder 22 may have a positioning member 222 which is movable in the front-rear direction, as depicted in FIG. 6. The positioning member 222 is a plate-shaped member having a guide surface 222B which aligns the front ends of the cut sheets Ks accommodated in the second accommodating part 30. The positioning member 222 positions the front ends of the cut sheets Ks by causing the guide surface 222B to contact with the front ends of the cut sheets Ks. Further, the support plate 31 in this modification has a length in the front-rear direction which is longer than that in the above-described embodiment. Furthermore, a part of the front end of the support plate 31 is inserted into the holder 22 and disposed on the bottom surface 11A. Moreover, the positioning member 222 is configured to be movable in the front-rear direction on the support plate 31. That is, the positioning member 222 can selectively switch the length of the second accommodating part 30 in the front-rear direction between the length L1 and the length L2 by being moved in the front-rear direction with respect to the first accommodating part 20. Further, the support surface 30A of the second accommodating part 30 in this modification is constructed of the upper surface 31A of the support plate 31. The length in the front-rear direction of the support surface 30A is changed to a length corresponding to the above-described length M1 or length M2 by moving the positioning member 222 in the front-rear direction.

In the present modification, the bottom wall 11 and the pair of side walls 12 and 13 of the feed tray 1 are configured so as not to be movable in the front-rear direction. Further, the length of the feed tray 1 in the front-rear direction is equal to the length of the feed tray 1 in the front-rear direction depicted in FIG. 4.

In the case of accommodating cut sheets Ks1 in the second accommodating part 30 of the feed tray 1 in this modification, the positioning member 222 is located at a position at which the positioning member 222 is connected to the holder 22. With this, the length of the second accommodating part 30 in the front-rear direction becomes the length L1, providing the state that the second accommodating part 30 can accommodate the cut sheets Ks1. Further, in the case of accommodating the cut sheets Ks2 in the second accommodating part 30 of the feed tray 1, the positioning member 222 is located at a position which is separated rearward from the holder 22, as depicted by two-dot chain lines in FIG. 6. With this, the length of the second accommodating part 30 in the front-rear direction becomes the length L2, providing the state that the second accommodating part 30 can accommodate the cut sheets Ks2.

Also in this modification, similarly to the above-described embodiment, even though the feed tray 1 has the first accommodating part 20 which accommodates the roll body R, the plurality of types of the cut sheet Ks1 and the cut sheet Ks2 of which sizes are mutually different can be accommodated in the second accommodating part 30. Further, by moving the positioning member 222 in the front-rear direction with respect to the first accommodating part 20, the length in the front-rear direction of the second accommodating part 30 can be changed as necessary.

Although the positioning member 222 constructs a part of the holder 22, the holder 22 or the support part 29 may be configured to be movable in the front-rear direction as the positioning member. In this case, the holder 22 or the support part 29 may be configured to be slidable in the front-rear direction on the bottom wall 11. Further, in this case, the support plate 31 may be disposed in an area ranging from the center to the rear part in the front-rear direction of the bottom surface 11A, similarly to the above-described embodiment, so that the length of the second accommodating part 30 is the length L1 or the length L2. Note that the support plate 31 may be detached in a case of accommodating the cut sheets Ks in the second accommodating part 30, or the support plate 31 may not be included in the feed tray 1. In this case, the support surface 30A of the second accommodating part 30 is constructed of the bottom surface 11A.

In the foregoing, although the embodiment of the present disclosure has been described, the present disclosure is not limited to the above-described embodiment, and various changes are possible within the scope of the claims. In the above-described embodiment and each of the modifications, although the second accommodating part 30 is configured to be capable of accommodating the various kinds of the cut sheets Ks, such as the cut sheets Ks of the A3 size or the legal size, or of the A4 size or the letter size, the second accommodating part 30 may accommodate cut sheets Ks of another size. Further, the feed tray 1 may be configured so that the length of the second accommodating part 30 in the front-rear direction can be changed, and the feed tray 1 may be configured so that the rear part of the second accommodating part 30 in the contracted state extends rearward to thereby cause the second accommodating part 30 to take the extended state. Furthermore, the feed tray 1 may be configured so that the center part in the front-rear direction of the second accommodating part 30 in the contracted state extends in the front-rear direction to thereby cause the second accommodating part 30 to take the extended state. Moreover, the feed tray 1 may be configured so that both the front part and the rear part of the second accommodating part 30 in the contracted state extend in the front-rear direction to thereby cause the second accommodating part 30 to take the extended state.

The support surface 30A of the second accommodating part 30 does not necessarily have to be continuous in the front-rear direction. For example, the support surface 30 may construct a support surface which supports the cut sheets Ks, with a plurality of surfaces separated in the front-rear direction.

Further, the feed tray 1 may be configured such that the length of the support surface 30A of the second accommodating part 30 in the front-rear direction can be changed. The upper surface 31A and the upper surface 11C1 may be disposed in the up-down direction reversely to that in the above-described embodiment. In a case where the support plate 31 is detached or omitted, the first bottom wall 11B and the second bottom wall 11C may be disposed in the up-down direction reversely to that in the above-described embodiment. Furthermore, the first bottom wall 11B and the second bottom wall 11C may be disposed side by side in the left-right direction, without overlapping with each other in the up-down direction.

Moreover, the pair of side walls 12 and 13 may have the first side walls 12B and 13B and the second side walls 12C and 13C, or may not have the connecting walls 12D and 13D. Further, the support plate 31 may be configured to be expanded and contracted in the front-rear direction according to the length of the second accommodating part 30 in the front-rear direction. Furthermore, the support plate 31 may have a front end connected to the holder 22, and this front end may move forward with respect to the first bottom wall 11B in a case where the first bottom wall 11B and the second bottom wall 11C are moved from the contracted position to the expanded position. The support surface 30A of the second accommodating part 30 while the first bottom wall 11B and the second bottom wall 11C are in the extended state is constructed of the upper surface 31A and the upper surface 11B1 of the first bottom wall 11B.

Moreover, the support part 29 may be omitted in the feed tray 1. In this case, the both ends of the roll body R in the left-right direction may be rotatably supported by the pair of side walls 12 and 13. In this case, the first accommodating part which accommodates the roll body R may be used as a part of the second accommodating part.

The present disclosure is generally applicable to an image recording apparatus including the feed tray 1 having the first accommodating part capable of accommodating the roll body R and the second accommodating part capable of accommodating the cut sheets Ks. The feed tray 1 may be supported to be movable with respect to the casing 100A, in a crossing direction which crosses the front-rear direction and the up-down direction. In this case, the first accommodating part 20 and the second accommodating part 30 may also be disposed side by side in the crossing direction.

For example, the present disclosure is applicable not only to an ink-jet printer including a head, as the recording part, which ejects ink from a nozzle, but is applicable also, for example, to an electrophotographic printer including a recording part of the laser system configured to form an electrostatic latent image by exposing a photoreceptor with a laser beam, or the LED system configured to form an electrostatic latent image by exposing a photoreceptor with an LED. Further, the sheet medium is not limited to a paper sheet, and may be cloth, resin materials such as films, etc., as long as having a sheet-like shape.

What is claimed is:

1. A tray, comprising:
a first accommodating part configured to accommodate a rolled first sheet medium; and
a second accommodating part disposed side by side with respect to the first accommodating part in a first direction and having a support surface configured to support a second sheet medium, the second accommodating part being configured to accommodate a plurality of sheets of the second sheet medium in a stacked state,
wherein the second accommodating part is configured to be either in a first state where a length of the support surface in the first direction is a first length, or in a second state where the length of the support surface in the first direction is a second length shorter than the first length.

2. The tray according to claim 1, wherein
the support surface has a first surface and a second surface which is relatively movable in the first direction with respect to the first surface,
in each of the first state and the second state of the second accommodating part, the first surface and the second surface overlap with each other in a direction orthogonal to the first surface, and
an overlap amount of the first surface and the second surface in a case of the second accommodating part being in the second state is greater than the overlap amount of the first surface and the second surface overlap in a case of the second accommodating part being in the first state.

3. The tray according to claim 2, further comprising a support part which is configured to support the rolled first sheet medium and which is detachably attached with respect to the first accommodating part.

4. The tray according to claim 1, further comprising a positioning member configured to position ends in the first direction of the plurality of sheets of the second sheet medium accommodated in the second accommodating part and configured to be moved in the first direction with respect to the first accommodating part,
wherein the second accommodating part is configured to be switched between the first state and the second state by moving the positioning member in the first direction with respect to the first accommodating part.

5. An image recording apparatus, comprising:
the tray as defined in claim 1; and
a casing configured to support the tray to be movable in the first direction,
wherein the casing has:
a recording part configured to record an image on each of the first sheet medium and the second sheet medium; and
a conveyor configured to convey the first sheet medium or the second sheet medium from the tray toward the recording part.
